(19) United States
(12) Patent Application Publication
(10) Pub. No.: US 2010/0074675 A1
(43) Pub. Date: Mar. 25, 2010

(54) JOINT FOR FURNITURE STRUCTURES

(75) Inventor: Bruno Nicoletti, Calderino di Monte S. Pietro (IT)

Correspondence Address: WILLIAM J. SAPONE;COLEMAN SUDOL SAPONE P.C., 714 COLORADO AVENUE, BRIDGE PORT, CT, 06605, US

(73) Assignee: METAL WORK S.r.l., Calderino di Monte S. Pietro (Bologna) (IT)

(21) Appl. No.: 12/519,267

(22) PCT Filed: Dec. 17, 2007
(86) PCT No.: PCT/IB07/03937

§ 371 Date: Aug. 3, 2009

(30) Foreign Application Priority Data
Dec. 22, 2006 (IT) BO2006A000878

(51) Int. Cl. F16B 12/40

(52) U.S. Cl. 403/190

(57) ABSTRACT

A joint for furniture structures which comprise first tubular elements (3) and a second tubular element (5) which are angularly arranged to one another. The joint (100) comprises: a main connecting element (1) which affords a first seating (11A) and a second seating (11B) which extend in opposite directions and are internally provided with respective first coupling organs (12); at least a pair of terminal connecting elements (2), associated to terminal portions of the first tubular elements (3) and externally provided with respective second coupling organs (21) which are complementary to the first coupling organs (12), and which pair of terminal connecting elements (2) respectively interest the first seating (11A) and the second seating (11B) to enable a reciprocal coupling of the first tubular elements (3) in a predetermined direction (L) and to define a perimeter opening (4) in a coupling zone between each seating (11A,11B) and a relative terminal connecting element (2); a second connecting element (51), internally associated to a terminal portion of the second tubular element (5), being provided with third coupling organs (52) for partially engaging the perimeter opening (4) and consequently enabling an engaging of the second tubular element (5) to a group defined by the first tubular elements (3), the main connecting element (1) and the terminal connecting elements (2).

### TECHNICAL FIELD

The invention relates to a joint for furniture structures.

### BACKGROUND ART

The prior art comprises systems for reciprocal blocking of elements constituting structures for furniture, such as uprights and crossbars.

For rational exploitation of spaces and optimal compositional flexibility of the furniture, the growing tendency is to provide furniture structures that are modular, implementable, easily assemblable and sturdy.

The aim of the present invention is to provide a joint for furniture structures which enables coupling of the elements making up the structure in a way which is fast and secure.

An additional aim of the present invention is to provide a joint which even a non-particularly expert operative can use to reciprocally associate elements constituting the structure, with the aid of a limited number of tools, or indeed without use of tools.

A further aim of the present invention consists in providing a joint which enables furniture structures to be realised which are provided with a high degree of sturdiness and stability.

To this can be added the desire to provide a joint which is made using a technical solution of simple conception, which is extremely functional and inexpensive.

DISCLOSURE OF INVENTION

The invention attains the above aims with a joint for furniture structures (which include first tubular elements and a second tubular element, reciprocally angularly arranged) comprising: a main connecting element which affords at least a first and a second seating extending in opposite direction and internally provided with respective first coupling organs; at least a pair of terminal connecting elements, constrained to the terminal portions of the first tubular elements and externally provided with respective second coupling elements, complementary to the first coupling elements, destined to interest respectively the first seating and the second seating in order to enable reciprocal coupling of the first tubular elements in a predetermined direction and to define a perimeter opening in the coupling zone between each seating and the relative terminal connecting element; a secondary connecting element, internally constrained to a terminal portion of the second tubular element, provided with third coupling organs destined to partially engage the circumferential opening and consequently enable an engaging of the second tubular element to the group defined by the first tubular elements, by the main connecting element and by the terminal connecting elements.

The proposed joint for furniture structures enables an easy, rapid and sturdy coupling of the elements constituting the same structure, giving it solidity.

Further, the characteristics of the joint are such as to enable even a not-particularly expert operative to reciprocally associate the elements constituting the structure without the aid of tools, or using a limited number of tools.

### BRIEF DESCRIPTION OF THE DRAWINGS

The characteristics of the invention will emerge in the following, in which a preferred but non-exclusive embodiment of the invention is described, with reference to the accompanying figures of the drawings, in which:

FIG. 1 illustrates a partially-exploded perspective view of the proposed joint of the invention, associated to elements of the structure;

FIGS. 1A and 1B represent further views, respectively a perspective view and a longitudinal section view, of a particularly significant component of the joint;

FIGS. 1C, 1D show respective perspective views, in different scales, of a further particular significant component of the joint, and of the component associated to an element of the structure;

FIGS. 2 and 3 illustrate views, respectively exploded perspective and perspective, of the joint and the components of the structure, with some elements not represented in order better to evidence others;

FIG. 4 is a lateral view, in partial section, of the joint associated to some elements of the structure;

FIGS. 4A, 4B show lateral views, in enlarged scale with respect to the preceding figure, of a component, already represented in FIG. 4, in respective operative configurations;

FIG. 5 is a section view of the joint associated to some components of the structure;

FIG. 5A represents, in enlarged scale, detail P of the preceding figure.

### BEST MODE FOR CARRYING OUT THE INVENTION

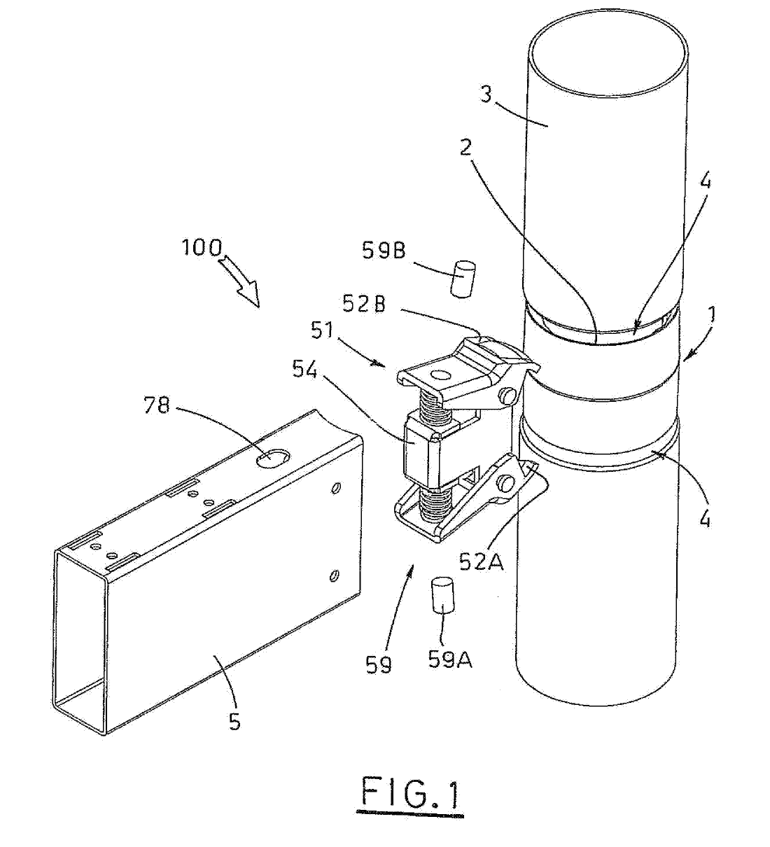

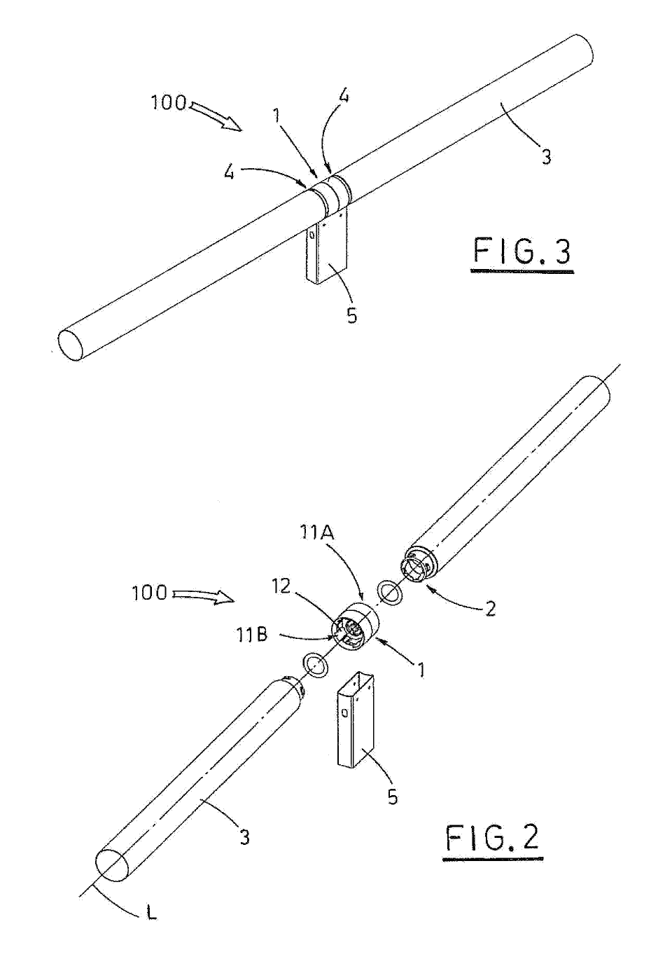

With reference to FIGS. 1, 2 and 3, 100 denotes in its entirety a joint for furniture structures which comprise at least two pairs of first tubular elements 3 (constituting for example a same number of uprights) and at least a second tubular element 5 (constituting for example a crossbar) which are angularly arranged to one another.

By way of example, the uprights 3 have a circular section, while the crossbar 5 has a rectangular section.

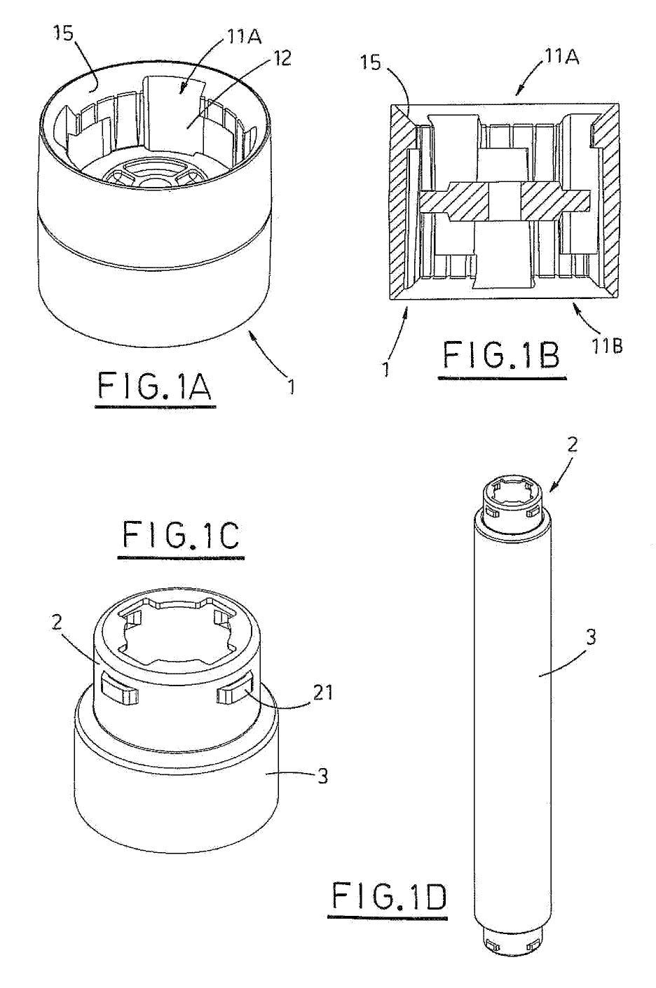

The joint 100 comprises a main connecting element 1, having for example a cylindrical shape, which affords a first seating 11A and a second seating 11B (also preferably cylindrical) which extend in opposite directions starting from the central portion of the main connecting element 1. The seatings 11A, 11B are internally provided with respective first coupling organs 12 (by way of example, a female bayonet coupling) (FIGS. 1A, 1B, 2).

With reference to FIGS. 1C, 1D, the joint 100 further comprises a pair of terminal connecting elements 2 (preferably cylindrical in shape) associated to the terminal portions of the tubular elements constituting the upright 3 and externally provided with respective second coupling organs 21 (for example constituted by a male bayonet coupling) complementary to the first coupling organs 12. The terminal connecting elements 2 respectively interest the first seating 11A and the second seating 11B to enable a reciprocal coupling of the first tubular elements in a predetermined direction L to obtain the upright 3 and to define a perimeter opening 4 in the coupling zone between each seating 11A, 11B and the relative terminal connecting element 2.

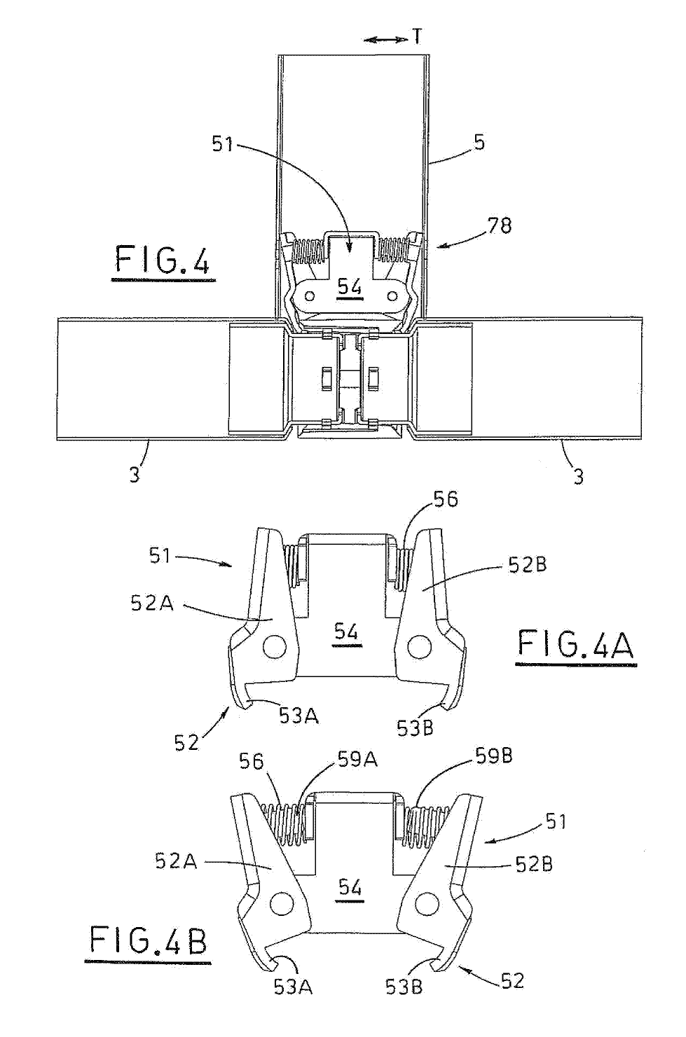

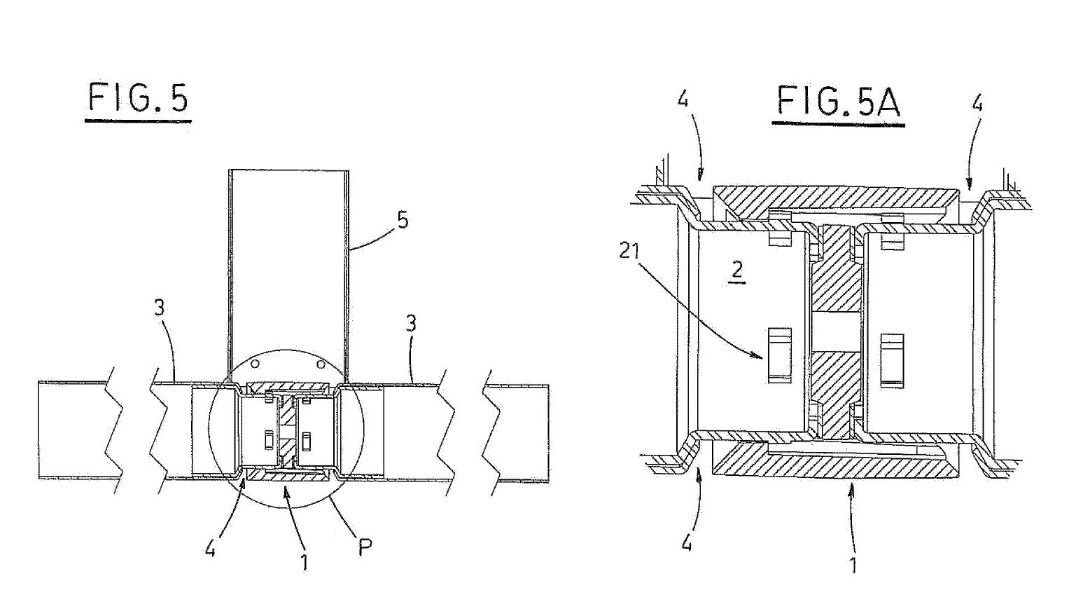

The joint 100 further comprises a secondary connecting element 51, internally associated to a terminal portion of the crossbar 5 and provided with third coupling organs 52 which engage the circumferential opening 4 at least partially and removably, and consequently enable engagement of the crossbar 5 to the group comprising the upright 3, the main connecting element 1 and the terminal connecting elements 2 (FIGS. 4, 5, 5A).

By way of example, the third coupling organs 52 are constituted by an element provided with a central body 54 which rotatably bears, on opposite lateral walls, a first jaw 52A and a second jaw 52B, ribs 53A, 53B of which partially engage the perimeter opening 4 (FIGS. 4, 4A, 4B, 5A).

The seatings (first seating 11A and second seating 11B) advantageously exhibit an external edge in which a countersink 15 is fashioned to facilitate the coupling between the ribs 53A, 53B and the main connecting element 1. A spring 56 is interposed between the central body 54 and each of the jaws 52A, 52B.

Stabilising organs 59 engage a threaded through-hole afforded by each jaw 52A, 52B and contact the central body 54; the stabilising organs 59 block the jaws 52A, 52B in a predetermined angular position with respect to the central body 54 with the aim of stabilising the coupling between the ribs 53A, 53B and the central connecting element 1. The stabilising organs 59 are preferably constituted by a pair of grub screws 59A, 59B (FIG. 1).

A through-hole 78 is afforded on opposite walls of the upright 5 to grant access to a tool for operating on the grub screws 59A, 59B.

The operating modalities for obtaining (by means of the joint 100) the upright 3 and for engaging the crossbar to the upright (again, by means of the joint 100) will now be briefly described, and should be easily deduced from the above description.

An operative first associates the first tubular elements to one another, by inserting the respective terminal connecting elements 2 into the corresponding seatings 11A, 11B such that they fit right down to the bottom of the seatings 11A, 11B.

The subsequent rotation performed by the operative on each first tubular element enables a reciprocal coupling between the first 12 and the second 21 bayonet organs in order to obtain an upright 3. One or more like uprights of the structure can be obtained using the same procedure.

It is stressed that the special conformation of the main connecting element 1 produces the two circumferential openings 4 in the coupling zones between each seating 11A, 11B and the respective first tubular elements.

The operative then nears the crossbar 5 to one of the uprights 3 such that a rib 53A of the jaw 52 engages a portion of a circumferential opening 4. Then the operator moves the crossbar 5 in a direction T which is transversal to the axis of the crossbar 5 such as to determine the oscillation of the jaws 52A, 52B in opposite directions, and thus the distancing of the ribs 53A, 53B (FIGS. 4A, 4B). The operation enables insertion of the remaining rib 53B in the remaining circumferential opening 4 and thus the hooking of the crossbar 5 to the upright 3.

By inserting a suitable tool (for example a screwdriver, a hex key, etc.) in the hole 78 afforded by the crossbar 5, the operative can turn the grub screws 59A, 59B to block the jaws 52A, 52B in the desired position and thus stabilise the fastening of the crossbar 5 to the upright 3.

Similar operations enable the remaining end of the crossbar 5 to be fastened to a further upright 3 to obtain, for example, a structure for supporting a work plane.

In the present description the first tubular elements constitute an upright 3 of the structure, and the second tubular element 5 constitutes the crossbar of the same structure; obviously the tubular elements 3,5 can constitute, in the case of the structure they are part of, uprights and/or crossbars.

From the above description it can be understood how the proposed joint enables realisation of very sturdy and stable furniture structures.

To this it can be added that the joint is obtained by means of a technical solution based on a simple, extremely functional and inexpensive concept.

The invention has obviously been described, with reference to the accompanying figures of the drawings, purely by way of non-limiting example, and it is therefore clear that all modifications and variants can be brought thereto, all falling within the ambit of protection as defined in the claims that follow.

1). A joint for furniture structures, comprising at least first tubular elements (3) and at least a second tubular element (5) which are angularly arranged to one another, characterised in that it comprises: a main connecting element (1) which affords at least a first seating (11A) and at least a second seating (11B) extending in opposite directions to one another starting from a central portion of the main connecting element (1), the at least a first seating (11A) and at least a second seating (11B) being internally provided with respective first coupling organs (12); at least a pair of terminal connecting elements (2), constrained to terminal portions of the first tubular elements (3) and externally provided with respective second coupling organs (21) which are complementary to the first coupling organs (12), which pair of terminal connecting elements (2)respectively interest the first seating (11A) and the second seating (11B) to enable a reciprocal coupling of the first tubular elements (3) in a predetermined direction (L) and to define a perimeter opening (4) in a coupling zone between each seating (11A,11B) and a relative terminal connecting element (2); a second connecting element (51), internally constrained to at least a terminal portion of the second tubular element (5), being provided with third coupling organs (52) for at least partially and removably engaging the perimeter opening (4) and consequently enabling an engaging of the second tubular element (5) to a group defined by the first tubular elements (3), the main connecting element (1) and the terminal connecting elements (2).

2). The device of claim 1, characterised in that the first coupling organs (12) are female coupling organs, and in that the first female coupling organs (12) are constituted by a female bayonet coupling.

3). The device of claim 1, characterised in that the second coupling organs (21) are male coupling organs, and in that the male coupling organs (21) are constituted by a male bayonet coupling.

4). The device of claim 1, characterised in that the third coupling organs (52) are constituted by an element provided with a central body (54) which rotatably bears, on opposite lateral sides thereof, a first jaw (52A) and a second jaw (52B), relative ribs (53A, 53B) of which first jaw (52A) and second jaw (52B) partially engage the perimeter opening (4).

5). The device of claim 4, characterised in that the first seating (11A) and the second seating (11B) exhibit external edges having a countersink (15) which facilitates coupling of the ribs (53A, 53B) and the main connecting element (1).

6). The device of claim 1, characterised in that the main connecting element (1) is cylindrical.

7). The device of claim 1, characterised in that the first seating (11A) and the second seating (11B) are cylindrical.

8). The device of claim 1, characterised in that the terminal connecting element (2) is cylindrical.

9). The device of claim 1, characterised in that the first tubular elements (3) exhibit a circular section.

10). The device of claim 1, characterised in that the second tubular element (5) exhibits a rectangular section.

11). The device of claim 4, characterised in that it comprises a spring (56) interposed between the central body (54) and each of the jaws (52A, 52B).

12). The device of claim 11, characterised in that it includes stabilising organs (59), associated to the jaws (52A, 52B) and coming into contact with the central body (54), which stabilising organs (59) block the jaws (52A, 52B) in a predetermined angular position with respect to the central body (54).

13). The device of claim 12, characterised in that the stabilising organs (59) are constituted by a pair of grub screws (59A, 59B).

14). The device of claim 13, characterised in that the second tubular element (5) affords a through hole (78) on opposite walls thereof for enabling access of a tool for turning the grub screws (59A, 59B).
